(19) United States
(12) Patent Application Publication
(10) Pub. No.: US 2003/0155028 A1
(43) Pub. Date: Aug. 21, 2003

(54) Fuel pump hose cover

(76) Inventor: Thomas F. Beane, Concord, NC (US)

Correspondence Address: Charles Y. Lackey, Post Office Box 5871, Winston-Salem, NC, 27113-5871, US

(21) Appl. No.: 10/078,574

(22) Filed: Feb. 20, 2002

(51) Int. Cl. F16L 57/00

(52) U.S. Cl. 138/110; 138/126; 138/128

(57) ABSTRACT

A replaceable fuel pump hose cover made from a tube of circularly knit yarn having a ground yarn surface and terry loops extending from the ground yarn surface. The yarn used in forming the cover is conventional multifilament crimped polyester or nylon yarn interspersed selectively with a carbon strand or strand segments, the strands effective for conducting electrostatic charges from the fuel pump and fuel pump hose to prevent electrostatic discharges that could occur from high electrostatic charge build-up particularly within the area of fuel and fume build-up.

### BACKGROUND OF THE INVENTION

1. Field of the Invention

This invention relates to covers for fuel pump hoses and more particularly to a replaceable fuel pump hose cover formed from a tube of circularly knit material including a synthetic yarn such as polyester or nylon with one or more carbon strands.

2. Description of the Prior Art

Covers for fuel pump hoses have traditionally been integrally and sealably formed around a tubular interior portion all of which prevents air and fuel leakage. The hose thus formed does not have a removable or detachable outer cover. Its outer surface is somewhat flexible and very strong to resist damage, wear and tear. In many instances, the outer hose surface is formed of metallic strands interwoven for strength and endurance.

The use of fuel dispensing equipment and fuel pump hoses associated therewith can result in a static build-up that periodically discharges often startling the user. In some cases, particular in such close association with fuel and fumes that surround such an installation, an explosion causing great physical damage can occur. One or more individuals utilizing this equipment can be seriously injured and even killed.

Electrostatic charges accumulate on the fuel pump hose exterior surface, the dispensing pump and other components associated with the hose and pump, and the dangers associated therewith are significant particularly when one pump is usually adjacent to one or more additional pumps thereby providing the possibility of a significant explosion involving all units.

Another problem associated with conventional fuel pumps and fuel pump hoses associated therewith is the hose surfaces usually become dirty and grimy as a result of continuous use over a period thus causing one operating the pump hose to get dirt, trash and/or stains on his or her hands or clothing. No standard operating routine appears to be in place at conventional fuel stations to regularly and frequently clean the hoses and associated equipment.

Thus there is a significant need to provide protection at fuel pumps, fuel pump hoses and associated equipment from the potential damaging effect of electrostatic discharges that occur from high electrostatic charge build-up during fuel pump use and to prevent the soiling of clothes and skin when dirty and oily fuel pump hoses are used by consumers who choose to dispense their on fuel to effect cost savings. It is to these needs that the present improvement is directed

### SUMMARY OF THE INVENTION

The present invention is a replaceable fuel pump hose cover for safely discharging electrostatic charges accumulating on the fuel pump hose, the fuel pump and equipment associated therewith which is formed from a tube of circularly knit material including synthetic multifilament, crimped yarn such as polyester or nylon and a carbon strand or strands the strand or strands effective to conduct or dissipate electrostatic charges from the hose, pump and supporting equipment. The circularly knit material includes a ground yam surface and terry loops extending from the ground yarn surface so that the terry loops provide a cushioning effect for the cover to resist damage and the carbon strand prevents electrostatic discharges that could occur from high electrostatic build-up with gas or fumes in the surrounding environment.

The fuel hose knit material can be removed, washed and returned to use and can be formed and can be formed to provide an aesthetic appearance. The cover can be made in varying diameters by utilizing circular knitting machine of appropriate cylinder diameters and using compatible yarn tensions with respect thereto. The cover can be provided with various means to secure it to the fuel pump hose at each end or at any other location. Because it is removable from the fuel pump hose, a clean hose cover can be installed at the time the soiled cover is removed so that soiled hands and clothing can be avoided when the pump and hose are used.

### OBJECTIVES OF THE INVENTION

From the foregoing brief description of the invention, it will be apparent that a primary objective of the present invention is to incorporate all the features and provide all of the advantages of prior art devices and more and none of the disadvantages.

Another objective of the present invention is to provide a fuel pump hose cover of the type described which will eliminate the likelihood of and ultimate damage from electrostatic build-up.

Another objective of the present invention is to provide a fuel pump hose cover of the type described which, because of its knit construction, will resist snagging as the hose is moved in an environment which causes to engage sharp edges and other potentially damaging items.

Another objective of the invention is to provide a fuel pump hose cover of the type described which, because of its construction, will not run if snagging does occur.

Yet another further objective of the present invention is to provide a fuel pump hose cover of the type described that can be washed and returned to use thus providing it with extended use life.

Yet still another further objective of the present invention is to provide a fuel pump hose cover which can be knit in varying diameters and which can receive one or more carbon strands of varying size.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is perspective and partial view of a fuel island having a plurality of dispensing pumps each equipped with a fuel hose covered by the fuel hose cover of the present invention;

FIG. 2 is an elevational view, in section, showing the fuel pump hose cover material of the present invention as installed about a fuel pump hose;

FIG. 3 is an elevational view, in section, showing the fuel pump hose cover installed about a fuel pump hose;

FIG. 4 is a perspective view from a ground yarn surface side of the fabric making up the fuel pump hose cover embodying the present invention;

FIG. 5 is a view similar to FIG. 40f the terry loop face of the fabric shown in FIG. 4;

FIG. 6 is a schematic representation of the knit stitch structure of the fabrics of Figs. and 5 particularly displaying the conductive carbon strand incorporated in the fuel pump hose cover and in accordance with the present invention; and

FIG. 7 is a perspective and sectional view of a fuel pump hose utilizing the fuel pump hose cover embodying the present inventive concept.

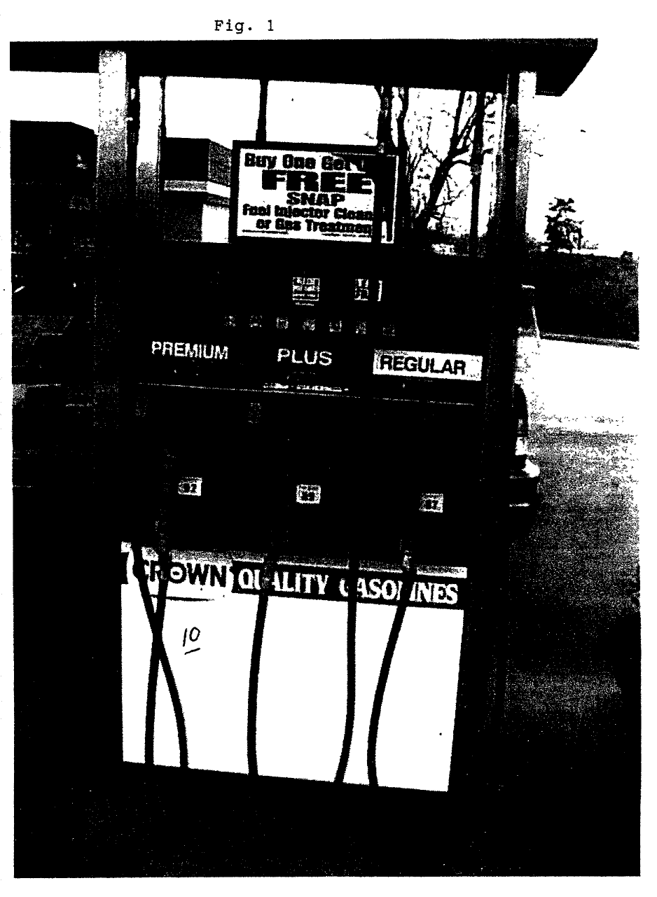

### DETAILED DESCRIPTION OF THE PREFERRED EMBODIMENT

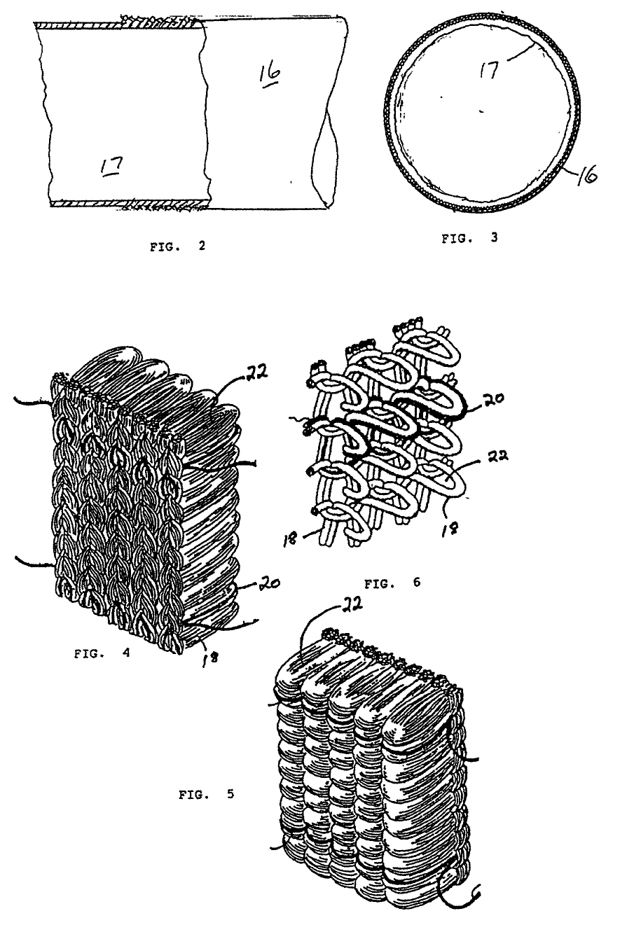

Referring now more particularly to the accompanying drawings, a fuel pump 10 utilizes a fuel hose assembly 12 extending to an adaptable connector 14 suitable for utilizing a number of different sized hoses. The present invention comprises a fuel pump hose cover shown generally as 16 which fits over hose 17 in the manner displayed best in FIGS. 2, 3 and 7. As various fuel pumps of different size and capacity utilize hoses of different sizes, the present invention can be modified to accommodate various hose sizes of diameters within the range of from 1 to 6 inches but more likely, the diameter will fall within the range of from 1 to 1 ¾ inches.

The fuel pump hose cover 11116 of the present invention includes a tube of circularly knit materials containing conventional synthetic yarn 18 such as polyester or nylon, preferably multifilament, and a metallic strand or strands 20 such as carbon. The synthetic yarn is knit into stitches defining a ground yarn surface with terry loops extending from the ground yarn surface to a predetermined height and a carbon strand or strands preferably around 24 denier with 4 filaments preferably falling within the range of from 15 to 30 denier. Specific ranges for the denier of the synthetic yarn and the and the height of the terry loops may be determined by persons skilled in the appropriate arts. For example, the fabric may be formed with yarn off 100 denier knit into stitches defining terry loop pile extending approximately 2 millimeters from the ground yarn surface.

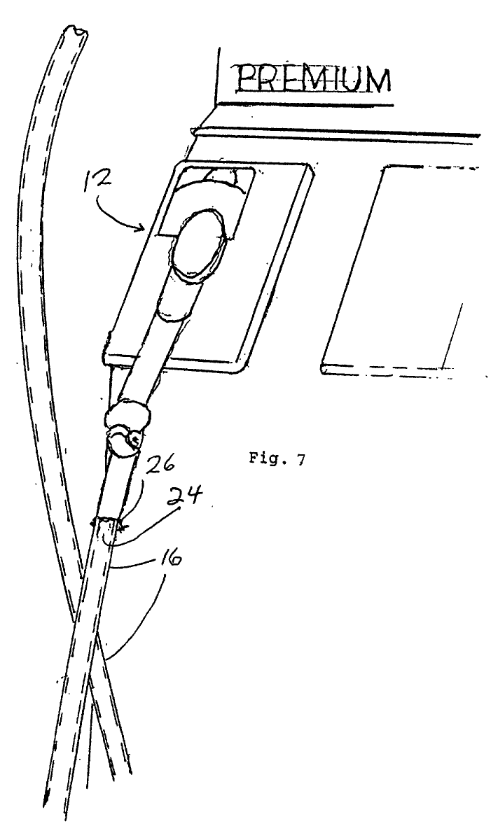

The objectives of the present invention directed to minimizing electrostatic discharges that can occur from high electrostatic charge build-up are accomplished by including carbon strand 20 to conduct electrostatic charge build-up from fuel 10 and fuel pump hose assembly 12. More particularly, the hose cover including carbon strand 20 which is knit with the synthetic forming a ground yarn surface and terry loops is shown enlarged in FIGS. 4, 5 and 6. In the enlarged schematic representation of FIG. 6, the conductive strand is indicated by darker shading than the synthetic yarn. Similarly, in FIGS. 4 and 5, the conductive strand is knit with a synthetic yarn forming pile or terry loops 22.

One operating embodiment of the present invention was constructed in accordance with the method in which a carbon strand 20 was knit with the synthetic yarn 18 forming the fabric The carbon strand was fed into a 6 feed knitting machine together with a synthetic yarn so as to form the strand and the yarn together in stitches defining the terry loop pile shown in FIGS. 4-6. The machine used in this embodiment has 6 feeds, and 2 yarns were fed into each feed, one feed including a synthetic yarn 18 along with carbon strand 20. Carbon stand 20 may be formed using relatively short lengths of metallic strands and will provide the conductive function required in accordance with the present invention.

The hose cover material providing a portion of the present is continuously knit so that the carbon strands 20 is uninterrupted throughout its length. Fuel hose cover 16 is connected to hose 17 at its ends (one end shown as 24 in FIG. 6) and, if desired, at other locations along its length so that when the complete installation is made, solid connection is made to ground in the apparatus to provide a dissipating location for the electrostatic charge build-up. The connecting element is preferable a drawstring shown as 26 in FIG. 6.

The fabric developed for the dissipating action of the pump and fuel hose to reduce the risk of electrostatic build-up discharge from the use of the dispenser and fuel hose.

Although one or more embodiments of the present invention have been shown and described, it will be obvious to those skilled in the art that the details of construction of these particular embodiments may be modified without departing from the concept presented. It is, therefore, intended that the invention be limited only by the scope of the appended claims rather than by particular details of construction shown.

What is claimed is:

1. A replaceable fuel hose cover for discharging electrostatic charges accumulating on the fuel pump and fuel pump hose during use comprising: a segment of tubular knitted yarn having a ground yarn surface and terry loops extending from the ground yard surface; a carbon strand knitted with the yarn and in the ground yarn surface and terry loops of the tube for conducting and dissipating electrostatic charges from the fuel pump and the fuel pump hose, the terry loops providing a cushioning effect for the fuel pump hose cover to resist area damage, hose snagging and hand and clothing stains and the carbon strand preventing electrostatic discharges that could occur from high electrostatic charge build-up and a possible explosion with fuel carried in the immediate environment.

2. The fuel pump hose cover as claimed in claim 1 further comprising: means for securing the fuel pump hose to the fuel pump hose.

3. The fuel pump hose cover as claimed in claim 1 wherein the fuel pump hose cover is snag resistant.

4. The fuel pump hose cover as claimed in claim 1 wherein the fuel pump hose cover is washable and reusable.

5. The fuel pump hose cover as claimed in claim 1 wherein the fuel pump hose cover has a diameter within the range of from 1 inch to 1 ¾ inches.

6. The fuel pump hose cover as claimed in claim 1 wherein the carbon strand is within the range of from 15 denier to 30 denier.

7. The fuel pump hose cover as claimed in claim 2 wherein the fuel pump hose cover is snag resistant.

8. The fuel pump hose cover as claimed in claim 7 wherein the fuel pump hose cover is washable and reusable.

9. The fuel pump hose cover as claimed in claim 8 wherein the fuel pump hose cover has a diameter within the range of from 1 inch to 1 ¾ inches.

10. The fuel pump hose cover as claimed in claim 9 wherein the fuel pump hose cover is snag resistant.

11. The fuel pump hose cover as claimed in claim 10 wherein the carbon strand is within the range of from 15 denier to 30 denier.

12. The fuel pump hose cover as claimed in claim 1 wherein the carbon strand contains from 2 to 12 filaments.

13. The fuel pump hose cover as claimed in claim 11 wherein the carbon strand contains from 2 to 12 filaments.

14. The fuel pump hose cover as claimed in claim 1 wherein the fuel pump hose cover has first and second ends and the first and second fuel pump hose cover ends each have means for securing the hose cover end to the fuel pump hose.
